(19) United States
(12) Patent Application Publication
(10) Pub. No.: US 2024/0098018 A1
(43) Pub. Date: Mar. 21, 2024

(54) SYSTEMS AND METHODS OF QOS MANAGEMENT OF WLAN DEVICES

(71) Applicant: Meta Platforms Technologies, LLC, Menlo Park, CA (US)

(72) Inventors: Guoqing Li, Cupertino, CA (US); Neelakantan Nurani Krishnan, San Jose, CA (US); Ruslan Shuster, Ramat Gan (IL)

(21) Appl. No.: 18/082,293

(22) Filed: Dec. 15, 2022

Related U.S. Application Data
(60) Provisional application No. 63/335,490, filed on Apr. 27, 2022.

(51) Int. Cl. H04L 45/302; H04L 45/74

(52) U.S. Cl. CPC H04L 45/302; H04L 45/74

(57) ABSTRACT

A device may one or more processors. The one or more processors may be configured to receive, via a transceiver from a first device, quality of service (QoS) information for traffic between the first device and an access point (AP). The one or more processors may be configured to wirelessly transmit, via the transceiver to the AP, a frame including address information of the first device and the QoS information.

### CROSS-REFERENCE TO RELATED APPLICATION

This application claims priority to U.S. Provisional Patent Application No. 63/335,490 filed on Apr. 27, 2022, which is incorporated by reference herein in its entirety for all purposes.

### FIELD OF DISCLOSURE

The present disclosure is generally related to communications, including but not limited systems and methods for a proxy-based quality of service (QoS) management protocol.

### BACKGROUND

Artificial reality such as a virtual reality (VR), an augmented reality (AR), or a mixed reality (MR) provides immersive experience to a user. In one example, a user wearing a head wearable display (HWD) can turn the user's head, and an image of a virtual object corresponding to a location of the HWD and a gaze direction of the user can be displayed on the HWD to allow the user to feel as if the user is moving within a space of artificial reality (e.g., a VR space, an AR space, or a MR space). An image of a virtual object may be generated by a console communicatively coupled to the HWD. In some embodiments, the console may have access to a network.

### SUMMARY

Various embodiments disclosed herein are related to a device (e.g., a proxy device) including one or more processors. In some embodiments, the one or more processors may be configured to receive, via a transceiver from a first device, quality of service (QoS) information (e.g., traffic profile/QoS requirements for the traffic) for traffic between the first device and an access point (AP). The one or more processors may be configured to wirelessly transmit, via the transceiver to the AP, a frame including address information of the first device (e.g., MAC address, source P address, source port) and the QoS information.

In some embodiments, the QoS information may include at least one of one or more traffic profiles or one or more QoS requirements for one or more traffic flows between the first device and the AP. In some embodiments, the address information of the first device may include at least one of medium access control (MAC) address, internet protocol (IP) address, or port of the first device.

In some embodiments, the frame is a stream classification service (SCS) request frame. The one or more processors may be configured to receive, via the transceiver from the AP, an SCS response frame in response to the SCS request frame. The frame may include one or more stream classification service (SCS) descriptor elements, which contain the address information of the first device and the QoS information.

In some embodiments, the one or more SCS descriptor elements may include a subfield of traffic class (TCLAS) element. The subfield of TCLAS element may include the address information of the first device. In some embodiments, the one or more SCS descriptor elements may include a subfield of medium access control (MAC) address which is set to a MAC address of the first device. In some embodiments, the one or more SCS descriptor elements may include a subfield of QoS characteristics element which is set to a MAC address of the first device.

In some embodiments, the one or more SCS descriptor elements may include a first SCS descriptor element and a second SCS descriptor element. The first SCS descriptor element may include the address information of the first device and the QoS information. The second SCS descriptor element may include address information of a second device and QoS information for traffic between the second device and the AP.

Various embodiments disclosed herein are related to a method including receiving, by one or more processors of a device, via a transceiver from a first device, quality of service (QoS) information for traffic between the first device and an access point (AP). The method may include wirelessly transmitting, via the transceiver of the device to the AP, a frame including address information of the first device and the QoS information.

In some embodiments, the QoS information may include at least one of one or more traffic profiles or one or more QoS requirements for one or more traffic flows between the first device and the AP. In some embodiments, the address information of the first device may include at least one of medium access control (MAC) address, internet protocol (IP) address, or port of the first device.

In some embodiments, the frame may be a stream classification service (SCS) request frame. The device may receive from the AP, an SCS response frame in response to the SCS request frame. In some embodiments, the frame may include one or more stream classification service (SCS) descriptor elements, which contain the address information of the first device and the QoS information.

In some embodiments, the one or more SCS descriptor elements may include a subfield of traffic class (TCLAS) element. The subfield of TCLAS element may include the address information of the first device. In some embodiments, the one or more SCS descriptor elements may include a subfield of medium access control (MAC) address which is set to a MAC address of the first device. In some embodiments, the one or more SCS descriptor elements may include a subfield of QoS characteristics element which is set to a MAC address of the first device.

In some embodiments, the one or more SCS descriptor elements may include a first SCS descriptor element and a second SCS descriptor element. The first SCS descriptor element may include the address information of the first device and the QoS information. The second SCS descriptor element may include address information of a second device and QoS information for traffic between the second device and the AP.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1A and FIG. 1B are diagrams of example scenarios in which an access point (AP) acts as a relay between client devices, according to an example implementation of the present disclosure.

FIG. 2A and FIG. 2B illustrate an example format of a stream classification service (SCS) descriptor element field, according to an example implementation of the present disclosure.

FIG. 3 is a diagram of a system environment including an artificial reality system, according to an example implementation of the present disclosure.

FIG. 4 is a diagram of a head wearable display, according to an example implementation of the present disclosure.

FIG. 5 is a block diagram of a computing environment according to an example implementation of the present disclosure.

FIG. 6 illustrates an example format of an SCS descriptor element field, according to an example implementation of the present disclosure.

FIG. 7A and FIG. 7B illustrate an example format of an SCS descriptor element field, according to another example implementation of the present disclosure.

FIG. 8 is a block diagram of a system workflow in which a proxy client device and an AP communicate data relating to QoS information, according to an example implementation of the present disclosure.

FIG. 9 is a block diagram of a system workflow in which a proxy client device and an AP communicate data relating to QoS information, according to another example implementation of the present disclosure.

FIG. 10 is a flowchart showing a process of communicating data relating to QoS information between a client device and an AP, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Disclosed herein are systems and methods related to providing quality of service (QoS) information between a client device and an access point (e.g., Wi-Fi AP). In some embodiments, a device (e.g., a computing device, a non-AP station (STA), a head wearable display (HWD)) may receive, via a transceiver from a first device (e.g., a computing device, a non-AP STA, a HWD), QoS information (e.g., one or more traffic profiles or one or more QoS requirements) for traffic between the first device and an AP (e.g., a console, a Wi-Fi AP). The device may wirelessly transmit, via the transceiver to the AP, a frame including address information of the first device and the QoS information.

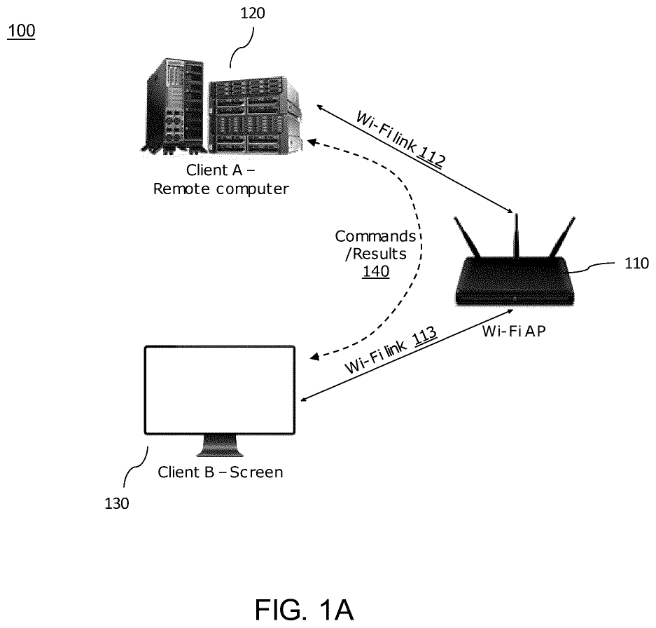

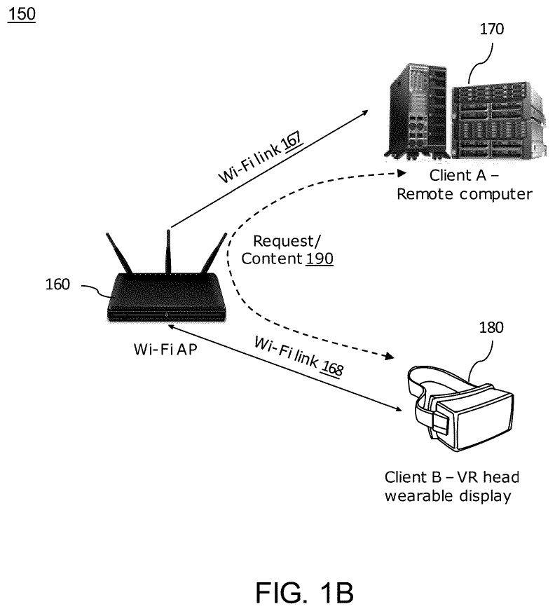

A wireless link (e.g., Wi-Fi link) may be established between a client device (e.g., an end-user Wi-Fi device) and an AP (e.g., a Wi-Fi AP), such that the AP may act as a gateway (e.g., the Internet gateway) to the client device. In some scenarios, a plurality of Wi-Fi enabled client devices, e.g., one or more augmented reality (AR) devices, one or more virtual reality (VR) devices, one or more remote desktop computer, etc., may communicate through/via an AP such that the AP acts as a relay between the client devices or a gateway to the client devices. FIG. 1A and FIG. 1B are diagrams of example scenarios in which AP acts as a relay between client devices or a gateway to the client devices, according to an example implementation of the present disclosure.

Referring FIG. 1A, one scenario 100 relating to remote desktop involves a Wi-Fi AP 110, a remote desktop computer 120 (“client A”), and a screen as an end-user device 130 (“client B”). The remote desktop computer 120 and the screen 130 communicate with the AP 110 through a Wi-Fi link 112 and a Wi-Fi link 113, respectively. A user may enter commands 140 in the screen (client B) and the commands may be executed in the remote desktop computer 120 (client A). Referring FIG. 1B, another scenario 150 relating to VR remote rendering involves a Wi-Fi AP 160, a remote computer 170 (“client A”), and a VR head wearable display (HWD) 180 (“client B”). The remote computer 170 and the HWD 180 communicate with the AP 160 through a Wi-Fi link 167 and a Wi-Fi link 168, respectively. The remote computer 170 as a VR remote rendering device (client A) may process and/or render VR content 190 to be displayed in the HWD 180 (client B).

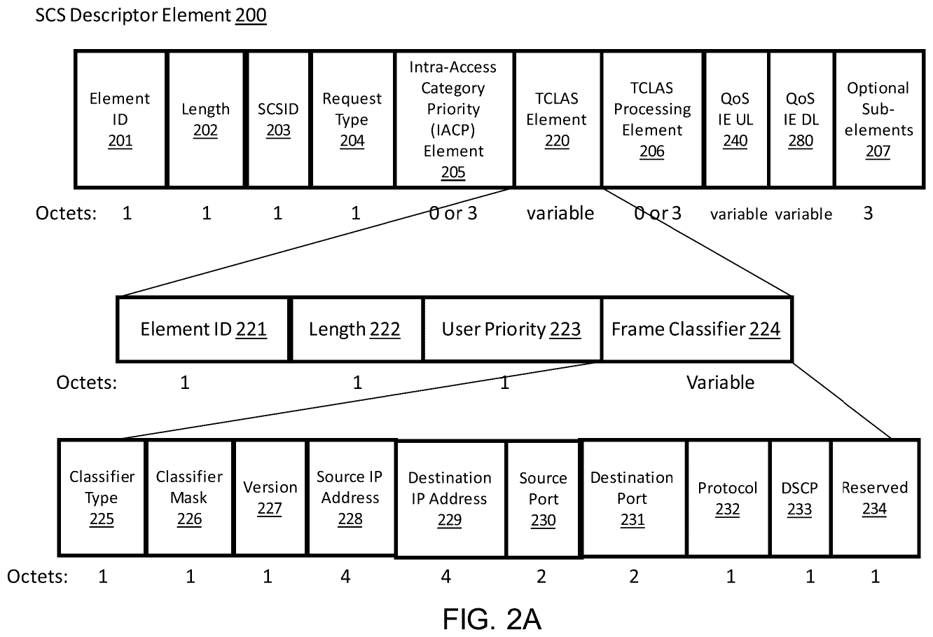

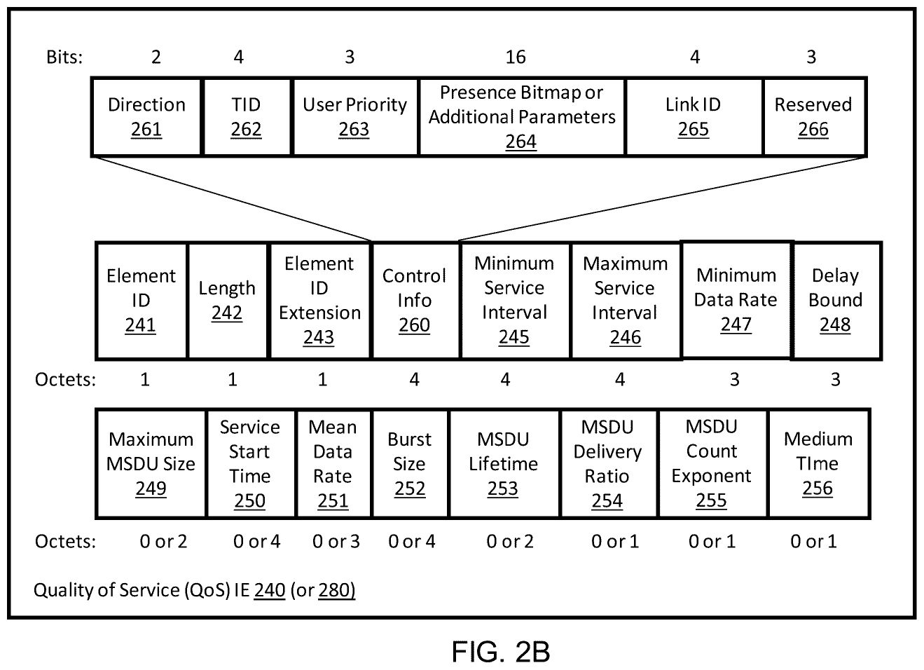

In both scenarios shown in FIG. 1A and FIG. 1B, the AP (e.g., AP 110, 160) may act as a relay between the client devices (e.g., client A and client B) present in the network (e.g., wireless local area network (WLAN)). Since all devices present in the network have data to transmit and receive, the devices may contend for channel access, which may increase the likelihood of packet collisions and increased channel access time, resulting in a poor experience of the user. If all client devices present in the network can signal traffic profile (e.g., QoS) information between the client devices and the AP, the AP can perform scheduling more intelligently to serve the client devices in an effective and timely manner. Such scheduling can eliminate packet collisions, minimize the delay in packet delivery, and hence fulfill QoS requirements of various traffic flows. In some cases, the signaling of traffic profile information can be facilitated using stream classification service (SCS) descriptor elements as shown in FIG. 2A and FIG. 2B.

FIG. 2A and FIG. 2B illustrate an example format of a stream classification service (SCS) descriptor element field (or SCS descriptor IE) 200, according to an example implementation of the present disclosure. The SCS descriptor IE may include the fields of element ID 201, length 202, SCSID (or SCSID) 203, request type 204, intra-access category priority element 205, one or more traffic classification (TCLAS) elements 220, TCLAS processing element 206, uplink QoS characteristic element (QoS IE UL) 240, downlink QoS characteristic element (QoS IE DL) 280, and/or one or more sub-elements 207 (optional). Each of the QoS IE UL 240 and the QoS IE DL 280 may have a format shown in FIG. 2B.

Referring to FIG. 2A, the SCSID field 203 may indicate an identifier (SCSID) identifying an SCS stream. For example, the exchange of SCS request/response frames may establish an SCS stream identified by an SCSID. For request type of “Add” or “Change” (indicated in the field of request type 204), an SCS request/response frame may include one or more TCLAS elements (e.g., TCLAS elements 220) to classify the traffic use in the SCS stream. For request type of “Add” (indicated in the field of request type 204), an SCS request/response frame may add a new SCS stream. For request type of “Change” (indicated in the field of request type 204), an SCS request/response frame may change parameters associated with an existing SCS stream. The field of intra-access category priority element 205 may indicate a drop eligibility by a Drop Eligibility Indicator (DEI) bit that specifies if frames from this traffic stream could be dropped if resources are insufficient. STAs utilizing SCS may set up one or more TCLAS elements (e.g., TCLAS element 220) and/or filters. For example, an AP may map an incoming traffic with a filter and can apply the QOS parameters (e.g., QoS parameters indicated in a QoS IE) to the matching/relevant traffic.

The TCLASS element field 220 may contain zero or more TCLAS elements to specify how incoming MAC service data units (MSDUs) are classified as part of an SCS stream. One or more TCLAS elements 220 may be present when the request type field (e.g., request type 204) is equal to “Add” or “Change,” and no TCLAS elements may be present when the request type field (e.g., request type 204) is equal to “Remove.” The TCLAS element field 220 may include the fields of element ID 221, length 222, user priority 223, and/or frame classifier 224. The frame classifier field 224 may describe a traffic profile of the frame. The frame classifier field 224 may include the subfields of classifier type 225, classifier mask 226, and a set of classifier parameters. The classifier type 225 may specify the type of classifier parameters in this TCLAS element. The classifier mask 226 may specify a bitmap wherein bits that are set to 1 identify a subset, out of the set, of the classifier parameters whose values must match those of the corresponding parameters in a given frame or MSDU. The set of classifier parameters may include the subfields of version 227, source internet protocol (IP) address 228, destination IP address 229, source port 230, destination port 231, differentiated services code point (DSCP) 232, protocol 233, and/or reserved 234. The set of classifier parameters may be used to identify an SCS stream. For example, a particular device may send an SCS request frame including an SCS descriptor element that specifies the source IP address, source port, protocol of the particular device in the subfields of source IP address, source port, and/or protocol of the TCLAS element.

In some embodiments, the QoS Characteristics element (e.g., QoS IE UL 240, QoS IE DL 280) included in an SCS frame may describe the traffic characteristics for the associated SCS stream (with an SCSID). For example, a QoS IE may provide QoS information (e.g., service interval, data rate, burst size, delay bound, etc.) per SCSID or SCS stream. The QoS IE may contain a set of parameters that define the characteristics and QoS expectations of a traffic flow, in the context of a particular non-AP EHT STA, for use by the EHT AP and the non-AP EHT STA in support of QoS traffic transfer using SCS procedures. FIG. 2B is an example format of a QoS IE UL filed 240 or a QoS IE DL filed, according to an example implementation of the present disclosure. The QoS IE UL 240 may include the fields of element ID 241, length 242, element ID extension 243, control information 260, minimum service interval 245, maximum service interval 246, minimum data rate 247, delay bound 248, maximum MSDU size 249, service start time 250, mean data rate 251, burst size 252, MSDU lifetime 253, MSDU delivery ratio 254, MSDU count exponent 255, and/or medium time 256. In some embodiments, the field of control information 260 may include the subfields of direction 261, TID 262, user priority 263, presence bitmap or additional parameters 264, link ID 265, and/or reserved 266.

Stream classification service (SCS) enables the establishment of a classification using layer 2 and/or layer 3 signaling to match incoming individually addressed MSDUs. Once classified, individually addressed MSDUs matching the classification may be assigned to an access category and may be tagged with drop eligibility of the individually addressed MSDUs. For example, the drop eligibility may be indicated by a Drop Eligibility Indicator (DEI) bit that specifies if frames from this traffic stream could be dropped if resources are insufficient. When intra-access category prioritization is enabled (e.g., using the field of intra-access category priority element), SCS allows MSDUs matching the classification to be assigned to the primary or alternate Enhanced Distribution Channel Access (EDCA) transmit queues so that finer grained prioritization can be applied. In some embodiments, a QoS Characteristics element (or QoS IE) may be carried in an SCS request frame and/or SCS response frame to specify QoS parameters for SCS streams. SCS feature may create a traffic classification and/or traffic filter for MSDUs on an access point (AP) and can specify the user priority and/or access category (AC) to assign to MSDUs that match the traffic classification. The SCS descriptor element (or SCS descriptor IE) may define information about a stream that is being classified using SCS procedures.

The SCS descriptor element (e.g., SCS descriptor element 200) may uniquely identify a traffic flow between an AP (e.g., Wi-Fi AP) and a client device (e.g., non-AP STA) and can characterize a traffic profile of the traffic flow between the AP and the client device (in terms of QoS requirements). For example, a TCLAS element (e.g., TCLAS element 220) can classify and/or uniquely identify a traffic flow, and QoS characteristics elements (e.g., QoS IE UL/QoS IE DL) can characterize the traffic flow in terms of the required QoS parameters by specifying the QoS requirements of the traffic flow identified by the TCLAS element. However, because not all client devices can support the use of SCS descriptor element, it may be difficult for the AP to perform a scheduling to serve all the client devices so as to eliminate packet collisions, minimize the delay in packet delivery, and fulfill QoS requirements of various traffic flows.

To address this problem, disclosed herein includes systems, devices and methods for using a proxy device (e.g., one of a client device) to indicate traffic profile information of traffic between one or more other devices present in a network (e.g., WLAN) and an AP (e.g., Wi-Fi AP) even in a case where the one or more other devices do not support or implements the use of SCS descriptors. This proxy device may be a client device in the network that supports and/or implements a modified version of SCS descriptor element. This scheme can gracefully extend to a case where a plurality of client devices are present in the network, as long as there is at least one client device (as the proxy device) that supports and/or implements the modified SCS descriptor element.

In one approach, a proxy QoS management protocol may define and/or describe various procedures relating to indication of traffic profile information between (1) a client device that does not support/implement the use of SCS descriptors (e.g., “client A” in FIG. 1A and FIG. 1B) and (2) an access point (e.g., Wi-Fi AP) through a client device (as a proxy device) that supports/implements the use of SCS descriptors (e.g., “client B” in FIG. 1A and FIG. 1B). The proxy device (e.g., client B) may carry traffic profile details of other client devices (e.g., client A; referred to as “target devices”) in the network.

In one approach, the proxy device may specify traffic profile information or QoS information relating to one or more target devices using a modified version of SCS descriptor element. In some embodiments, an SCS descriptor element may be modified such that the field of MAC address may be added to the SCS descriptor element that identifies a target device for which the traffic profile information is conveyed in the SCS descriptor element. The MAC address field may contain a MAC address of the target device. In some embodiments, the MAC address field may be added to the SCS descriptor element itself (as a field of the SCS descriptor element). In some embodiments, the MAC address field may be added to one of the elements contained within the SCS descriptor element (e.g., TCLAS element contained within the SCS descriptor element). In some embodiments, the proxy device may use the SCS element to identity of the target device, and to specify a traffic profile and/or QoS requirements for a traffic flow between the identified target device and an AP (e.g., Wi-Fi AP).

In one approach, a target device (which may not support and/or implement the use of SCS descriptor) may communicate, to a proxy device (which may support and/or implement the use of SCS descriptor), traffic profile information and QoS information relating to the target device. The traffic profile information may include one or more of MAC address, source IP address, source port, transport protocol of a traffic flow between the target device and an AP. The QoS information may include QoS requirements of the traffic flow between the target device and the AP. The QoS information may be specified in one or more fields in a QoS characteristics element (or QoS IE). In some embodiments, the traffic information and/or QoS information may be exchanged and/or communicated between one or more target devices and the proxy device at the time of application setup (e.g., when the target devices and/or the proxy device set up an application that performs communication between the target devices and the proxy device).

In one approach, one or more traffic flows and/or one or more traffic profiles tied or pertaining to a target device may be carried/contained in an SCS descriptor element. In some embodiments, the SCS descriptor element may include a MAC address field that contains a MAC address of the target device, and the SCS descriptor element may be carried/transmitted by a proxy device. In some embodiments, an element/field/bits of the SCS descriptor element other than the MAC address field of the SCS descriptor element may contain a MAC address of the target device. In some embodiments, the SCS descriptor element may contain a MAC address that identifies the device for which the rest of the element is valid (e.g., MAC address of a target device). In some embodiments, the SCS descriptor element may contain one or more traffic profiles tied or pertaining to the target device in a traffic class (TCLAS) element that classifies and/or uniquely identifies a traffic flow between the target device and an AP. The one or more traffic profiles may include at least one of a source IP address, a source port, or a protocol, tied to or pertaining to the target device. In some embodiments, the SCS descriptor element may include the fields of QoS characteristics element UL (QoS IE UL) and/or QoS characteristics element DL (QoS IE DL) which characterize an UL traffic flow or a DL traffic flow (between the target device and the AP) in terms of required QoS parameters.

In one approach, the MAC address of the target device may be added to one or more elements contained within the SCS descriptor element carried by the proxy device. In some embodiments, the MAC address of the target device may be added to one or more elements, one or more fields, or one or more bits, other than the SCS descriptor element. In some embodiments, the MAC address of the target device may be added to a target MAC address subfield of a TCLAS element contained in the SCS descriptor element. In some embodiments, a frame classifier field of a TCLAS element that classifies and/or uniquely identifies a traffic flow (between the target device and the AP) may include the subfields of target MAC address, target source IP address, target source port, and/or target protocol, which respectively contain a MAC address, a source IP address, a source port and/or protocol of the target device (or tied to or pertaining to the target device).

In some embodiments, the MAC address of the target device may be added to a target MAC address subfield of a QoS characteristics element (e.g., QoS IE UL or QoS IE DL contained in the SCS descriptor element) that characterizes a traffic flow between the target device and the AP in terms of required QoS parameters. In some embodiments, the MAC address of the target device (specified in the QoS characteristics element) may act as the key to map QoS characteristics (specified in the QoS characteristics element) to a traffic flow between the target device and the AP.

In one approach, a proxy device may send, to an AP, an SCS request (e.g., SCS request frame) for specifying one or more streams relating to the proxy device. In response to the SCS request for the proxy device, the AP may send a corresponding SCS response (e.g., SCS response frame). The proxy device may send, to the AP, an SCS request (e.g., SCS request frame) for specifying one or more streams relating to each of a plurality of client devices (as target devices), separately. In response to the SCS request for each client device, the AP may send a corresponding SCS response (e.g., SCS response frame). In some embodiments, the SCS request frame for each client device may include a modified version of SCS descriptor element such that the modified SCS descriptor element contain traffic profile information and/or QoS information relating to traffic between each client device and the AP. In some embodiments, in response to receiving the SCS request frames for the plurality of client devices and sending the SCS response frames corresponding to the SCS request frames, the AP may schedule/allocate respective times for the proxy device and each of the plurality of client devices. In some embodiments, the AP may schedule/allocate respective times for the proxy device and each of the plurality of client devices in the same order as that of receiving requests corresponding to the proxy device and each of the plurality of client devices. In some embodiments, the AP may schedule/allocate respective times for the proxy device and each of the plurality of client devices in an order different from that of receiving requests corresponding to the proxy device and each of the plurality of client devices.

In one approach, a proxy device may send, to an AP, an SCS request (e.g., a single SCS request frame) for specifying one or more streams relating to the proxy device as well as a plurality of client devices (as target devices). In some embodiments, the SCS request frame for the proxy device and the plurality of client devices may include (1) an SCS descriptor element containing traffic profile information and/or QoS information relating to traffic between the proxy device and the AP and (2) a plurality of modified SCS descriptor elements such that each of the plurality of modified SCS descriptor elements contains traffic profile information and/or QoS information relating to traffic between each client device and the AP, respectively. In response to receiving the single SCS request frame, the AP may send a corresponding SCS response (e.g., SCS response frame). In some embodiments, in response to receiving the single SCS request frame and sending the corresponding SCS response frame, the AP may schedule/allocate respective times for the proxy device and each of the plurality of client devices. In some embodiments, the AP may schedule/allocate respective times for the proxy device and each of the plurality of client devices in the same order as an order of the SCS descriptor elements specified in the single SCS request frame. In some embodiments, the AP may schedule/allocate respective times for the proxy device and each of the plurality of client devices in an order different from an order of the SCS descriptor elements specified in the single SCS request frame.

In one approach, a device may include one or more processors and/or a transceiver. The one or more processors may receive, via the transceiver from a first device, quality of service (QoS) information for traffic between the first device and an access point (AP). The one or more processors may wirelessly transmit, via the transceiver to the AP, a frame including address information of the first device and the QoS information.

In some embodiments, the QoS information may include at least one of one or more traffic profiles or one or more QoS requirements for one or more traffic flows between the first device and the AP. In some embodiments, the address information of the first device may include at least one of medium access control (MAC) address, internet protocol (IP) address, or port of the first device.

In some embodiments, the frame is a stream classification service (SCS) request frame. The one or more processors may be configured to receive, from the AP, an SCS response frame in response to the SCS request frame. The frame may include one or more stream classification service (SCS) descriptor elements, which contain the address information of the first device and the QoS information.

In some embodiments, the one or more SCS descriptor elements may include a subfield of traffic class (TCLAS) element. The subfield of TCLAS element may include the address information of the first device. In some embodiments, the one or more SCS descriptor elements may include a subfield of medium access control (MAC) address which is set to a MAC address of the first device. In some embodiments, the one or more SCS descriptor elements may include a subfield of QoS characteristics element which is set to a MAC address of the first device.

In some embodiments, the one or more SCS descriptor elements may include a first SCS descriptor element and a second SCS descriptor element. The first SCS descriptor element may include the address information of the first device and the QoS information. The second SCS descriptor element may include address information of a second device and QoS information for traffic between the second device and the AP.

Embodiments in the present disclosure have at least the following advantages and benefits.

First, embodiments in the present disclosure can provide useful techniques for an AP (e.g., Wi-Fi/WLAN AP) assimilating/acquiring/understanding traffic profile information of all the devices present in a network (e.g., WLAN) to intelligently schedule the devices for uplink (UL) and/or downlink (DL) transmission, even in a case where not all of the devices support and/or implement the use of SCS descriptor element. This configuration can result in several discernible benefits such as fewer packet collisions, lower delay in transporting packets, and/or increased opportunities for devices to enter power-save mode since traffic can be scheduled by the AP in both downlink and uplink directions, thereby increasing battery efficiency.

Second, embodiments in the present disclosure can provide useful techniques for an AP that is intelligently scheduling/allocating times for multiple devices. e.g., determining how the wireless channel can be shared among the client devices when the multiple client devices are present in a network (e.g., WLAN).

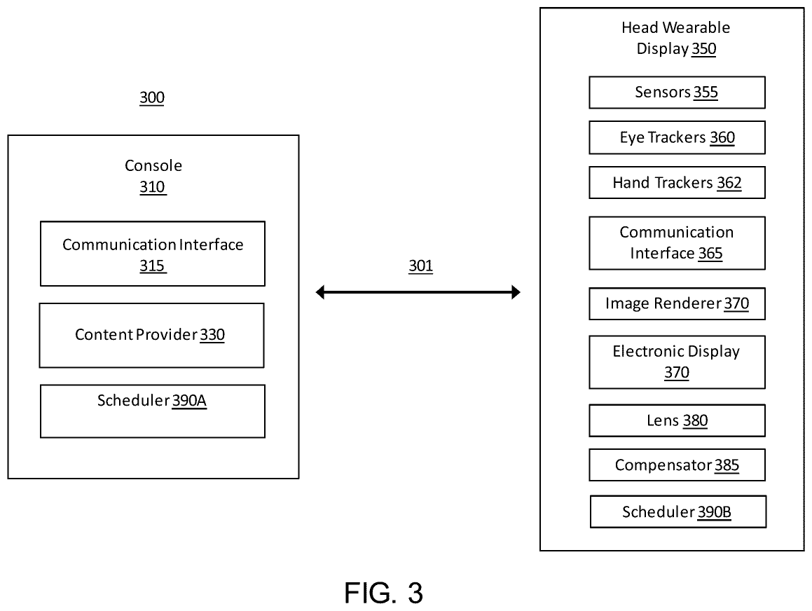

FIG. 3 is a block diagram of an example artificial reality system environment 300 in which a console 310 (e.g., an AP or soft AP) operates. FIG. 3 provides an example environment in which devices may communicate traffic streams with different latency sensitivities/requirements. In some embodiments, the artificial reality system environment 300 includes a HWD 350 worn by a user, and a console 310 providing content of artificial reality to the HWD 350. A head wearable display (HWD) may be referred to as, include, or be part of a head mounted display (HMD), head mounted device (HMD), head wearable device (HWD), head worn display (HWD) or head worn device (HWD). In one aspect, the HWD 350 may include various sensors to detect a location, an orientation, and/or a gaze direction of the user wearing the HWD 350, and provide the detected location, orientation and/or gaze direction to the console 310 through a wired or wireless connection. The HWD 350 may also identify objects (e.g., body, hand face).

The console 310 may determine a view within the space of the artificial reality corresponding to the detected location, orientation and/or the gaze direction, and generate an image depicting the determined view. The console 310 may also receive one or more user inputs and modify the image according to the user inputs. The console 310 may provide the image to the HWD 350 for rendering. The image of the space of the artificial reality corresponding to the user's view can be presented to the user. In some embodiments, the artificial reality system environment 300 includes more, fewer, or different components than shown in FIG. 3. In some embodiments, functionality of one or more components of the artificial reality system environment 300 can be distributed among the components in a different manner than is described here. For example, some of the functionality of the console 310 may be performed by the HWD 350, and/or some of the functionality of the HWD 350 may be performed by the console 310.

In some embodiments, the HWD 350 is an electronic component that can be worn by a user and can present or provide an artificial reality experience to the user. The HWD 350 may render one or more images, video, audio, or some combination thereof to provide the artificial reality experience to the user. In some embodiments, audio is presented via an external device (e.g., speakers and/or headphones) that receives audio information from the HWD 350, the console 310, or both, and presents audio based on the audio information. In some embodiments, the HWD 350 includes sensors 355, eye trackers 360, a communication interface 365, an image renderer 370, an electronic display 375, a lens 380, and a compensator 385. These components may operate together to detect a location of the HWD 350 and/or a gaze direction of the user wearing the HWD 350, and render an image of a view within the artificial reality corresponding to the detected location of the HWD 350 and/or the gaze direction of the user. In other embodiments, the HWD 350 includes more, fewer, or different components than shown in FIG. 3.

In some embodiments, the sensors 355 include electronic components or a combination of electronic components and software components that detect a location and/or an orientation of the HWD 350. Examples of sensors 355 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 355 detect the translational movement and/or the rotational movement, and determine an orientation and location of the HWD 350. In one aspect, the sensors 355 can detect the translational movement and/or the rotational movement with respect to a previous orientation and location of the HWD 350, and determine a new orientation and/or location of the HWD 350 by accumulating or integrating the detected translational movement and/or the rotational movement. Assuming for an example that the HWD 350 is oriented in a direction 25 degrees from a reference direction, in response to detecting that the HWD 350 has rotated 20 degrees, the sensors 355 may determine that the HWD 350 now faces or is oriented in a direction 45 degrees from the reference direction. Assuming for another example that the HWD 350 was located two feet away from a reference point in a first direction, in response to detecting that the HWD 350 has moved three feet in a second direction, the sensors 355 may determine that the HWD 350 is now located at a vector multiplication of the two feet in the first direction and the three feet in the second direction.

In some embodiments, the eye trackers 360 include electronic components or a combination of electronic components and software components that determine a gaze direction of the user of the HWD 350. In some embodiments, the HWD 350, the console 310 or a combination may incorporate the gaze direction of the user of the HWD 350 to generate image data for artificial reality. In some embodiments, the eye trackers 360 include two eye trackers, where each eye tracker 360 captures an image of a corresponding eye and determines a gaze direction of the eye. In one example, the eye tracker 360 determines an angular rotation of the eye, a translation of the eye, a change in the torsion of the eye, and/or a change in shape of the eye, according to the captured image of the eye, and determines the relative gaze direction with respect to the HWD 350, according to the determined angular rotation, translation and the change in the torsion of the eye. In one approach, the eye tracker 360 may shine or project a predetermined reference or structured pattern on a portion of the eye, and capture an image of the eye to analyze the pattern projected on the portion of the eye to determine a relative gaze direction of the eye with respect to the HWD 350. In some embodiments, the eye trackers 360 incorporate the orientation of the HWD 350 and the relative gaze direction with respect to the HWD 350 to determine a gaze direction of the user. Assuming for an example that the HWD 350 is oriented at a direction 30 degrees from a reference direction, and the relative gaze direction of the HWD 350 is −10 degrees (or 350 degrees) with respect to the HWD 350, the eye trackers 360 may determine that the gaze direction of the user is 20 degrees from the reference direction. In some embodiments, a user of the HWD 350 can configure the HWD 350 (e.g., via user settings) to enable or disable the eye trackers 360. In some embodiments, a user of the HWD 350 is prompted to enable or disable the eye trackers 360.

In some embodiments, the hand tracker 362 includes an electronic component or a combination of an electronic component and a software component that tracks a hand of the user. In some embodiments, the hand tracker 362 includes or is coupled to an imaging sensor (e.g., camera) and an image processor that can detect a shape, a location and/or an orientation of the hand. The hand tracker 362 may generate hand tracking measurements indicating the detected shape, location and/or orientation of the hand.

In some embodiments, the communication interface 365 includes an electronic component or a combination of an electronic component and a software component that communicates with the console 310. The communication interface 365 may communicate with a communication interface 315 of the console 310 through a communication link. The communication link may be a wireless link, a wired link, or both. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the console 310 and the head wearable display 350 are implemented on a single system, the communication interface 365 may communicate with the console 310 through a bus connection or a conductive trace. Through the communication link, the communication interface 365 may transmit to the console 310 sensor measurements indicating the determined location of the HWD 350, orientation of the HWD 350, the determined gaze direction of the user, and/or hand tracking measurements. Moreover, through the communication link, the communication interface 365 may receive from the console 310 sensor measurements indicating or corresponding to an image to be rendered.

Using the communication interface, the console 310 (or HWD 350) may coordinate operations on link 301 to reduce collisions or interferences. For example, the console 310 may coordinate communication between the console 310 and the HWD 350. In some implementations, the console 310 may transmit a beacon frame periodically to announce/advertise a presence of a wireless link between the console 310 and the HWD 350 (or between two HWDs). In an implementation, the HWD 350 may monitor for or receive the beacon frame from the console 310, and can schedule communication with the HWD 350 (e.g., using the information in the beacon frame, such as an offset value) to avoid collision or interference with communication between the console 310 and/or HWD 350 and other devices.

The console 310 and HWD 350 may communicate using link 301 (e.g., intralink). Data (e.g., a traffic stream) may flow in a direction on link 301. For example, the console 310 may communicate using a downlink (DL) communication to the HWD 350 and the HWD 350 may communicate using an uplink (UL) communication to the console 310.

In some embodiments, the image renderer 370 includes an electronic component or a combination of an electronic component and a software component that generates one or more images for display, for example, according to a change in view of the space of the artificial reality. In some embodiments, the image renderer 370 is implemented as a processor (or a graphical processing unit (GPU)) that executes instructions to perform various functions described herein. The image renderer 370 may receive, through the communication interface 365, data describing an image to be rendered, and render the image through the electronic display 375. In some embodiments, the data from the console 310 may be encoded, and the image renderer 370 may decode the data to generate and render the image. In one aspect, the image renderer 370 receives the encoded image from the console 310, and decodes the encoded image, such that a communication bandwidth between the console 310 and the HWD 350 can be reduced.

In some embodiments, the image renderer 370 receives, from the console, 310 additional data including object information indicating virtual objects in the artificial reality space and depth information indicating depth (or distances from the HWD 350) of the virtual objects. Accordingly, the image renderer 370 may receive from the console 310 object information and/or depth information. The image renderer 370 may also receive updated sensor measurements from the sensors 355. The process of detecting, by the HWD 350, the location and the orientation of the HWD 350 and/or the gaze direction of the user wearing the HWD 350, and generating and transmitting, by the console 310, a high resolution image (e.g., 1920 by 1080 pixels, or 2048 by 1152 pixels) corresponding to the detected location and the gaze direction to the HWD 350 may be computationally exhaustive and may not be performed within a frame time (e.g., less than 11 ms or 8 ms).

In some implementations, the image renderer 370 may perform shading, reprojection, and/or blending to update the image of the artificial reality to correspond to the updated location and/or orientation of the HWD 350. Assuming that a user rotated their head after the initial sensor measurements, rather than recreating the entire image responsive to the updated sensor measurements, the image renderer 370 may generate a small portion (e.g., 10%) of an image corresponding to an updated view within the artificial reality according to the updated sensor measurements, and append the portion to the image in the image data from the console 310 through reprojection. The image renderer 370 may perform shading and/or blending on the appended edges. Hence, without recreating the image of the artificial reality according to the updated sensor measurements, the image renderer 370 can generate the image of the artificial reality.

In other implementations, the image renderer 370 generates one or more images through a shading process and a reprojection process when an image from the console 310 is not received within the frame time. For example, the shading process and the reprojection process may be performed adaptively, according to a change in view of the space of the artificial reality.

In some embodiments, the electronic display 375 is an electronic component that displays an image. The electronic display 375 may, for example, be a liquid crystal display or an organic light emitting diode display. The electronic display 375 may be a transparent display that allows the user to see through. In some embodiments, when the HWD 350 is worn by a user, the electronic display 375 is located proximate (e.g., less than 3 inches) to the user's eyes. In one aspect, the electronic display 375 emits or projects light towards the user's eyes according to image generated by the image renderer 370.

In some embodiments, the lens 380 is a mechanical component that alters received light from the electronic display 375. The lens 380 may magnify the light from the electronic display 375, and correct for optical error associated with the light. The lens 380 may be a Fresnel lens, a convex lens, a concave lens, a filter, or any suitable optical component that alters the light from the electronic display 375. Through the lens 380, light from the electronic display 375 can reach the pupils, such that the user can see the image displayed by the electronic display 375, despite the close proximity of the electronic display 375 to the eyes.

In some embodiments, the compensator 385 includes an electronic component or a combination of an electronic component and a software component that performs compensation to compensate for any distortions or aberrations. In one aspect, the lens 380 introduces optical aberrations such as a chromatic aberration, a pin-cushion distortion, barrel distortion, etc. The compensator 385 may determine a compensation (e.g., predistortion) to apply to the image to be rendered from the image renderer 370 to compensate for the distortions caused by the lens 380, and apply the determined compensation to the image from the image renderer 370. The compensator 385 may provide the predistorted image to the electronic display 375.

In some embodiments, the console 310 is an electronic component or a combination of an electronic component and a software component that provides content to be rendered to the HWD 350. In one aspect, the console 310 includes a communication interface 315 and a content provider 330. These components may operate together to determine a view (e.g., a field of view (FOV) of the user) of the artificial reality corresponding to the location of the HWD 350 and/or the gaze direction of the user of the HWD 350, and can generate an image of the artificial reality corresponding to the determined view. In other embodiments, the console 310 includes more, fewer, or different components than shown in FIG. 3. In some embodiments, the console 310 is integrated as part of the HWD 350. In some embodiments, the communication interface 315 is an electronic component or a combination of an electronic component and a software component that communicates with the HWD 350. The communication interface 315 may be a counterpart component to the communication interface 365 to communicate with a communication interface 315 of the console 310 through a communication link (e.g., USB cable, a wireless link). Through the communication link, the communication interface 315 may receive from the HWD 350 sensor measurements indicating the determined location and/or orientation of the HWD 350, the determined gaze direction of the user, and/or hand tracking measurements. Moreover, through the communication link, the communication interface 315 may transmit to the HWD 350 data describing an image to be rendered.

The content provider 330 can include or correspond to a component that generates content to be rendered according to the location and/or orientation of the HWD 350, the gaze direction of the user and/or hand tracking measurements. In one aspect, the content provider 330 determines a view of the artificial reality according to the location and orientation of the HWD 350 and/or the gaze direction of the user of the HWD 350. For example, the content provider 330 maps the location of the HWD 350 in a physical space to a location within an artificial reality space, and determines a view of the artificial reality space along a direction corresponding to an orientation of the HWD 350 and/or the gaze direction of the user from the mapped location in the artificial reality space.

The content provider 330 may generate image data describing an image of the determined view of the artificial reality space, and transmit the image data to the HWD 350 through the communication interface 315. The content provider may also generate a hand model (or other virtual object) corresponding to a hand of the user according to the hand tracking measurement, and generate hand model data indicating a shape, a location, and an orientation of the hand model in the artificial reality space.

In some embodiments, the content provider 330 generates metadata including motion vector information, depth information, edge information, object information, etc., associated with the image, and transmits the metadata with the image data to the HWD 350 through the communication interface 315. The content provider 330 may encode and/or encode the data describing the image, and can transmit the encoded and/or encoded data to the HWD 350. In some embodiments, the content provider 330 generates and provides the image to the HWD 350 periodically (e.g., every one second).

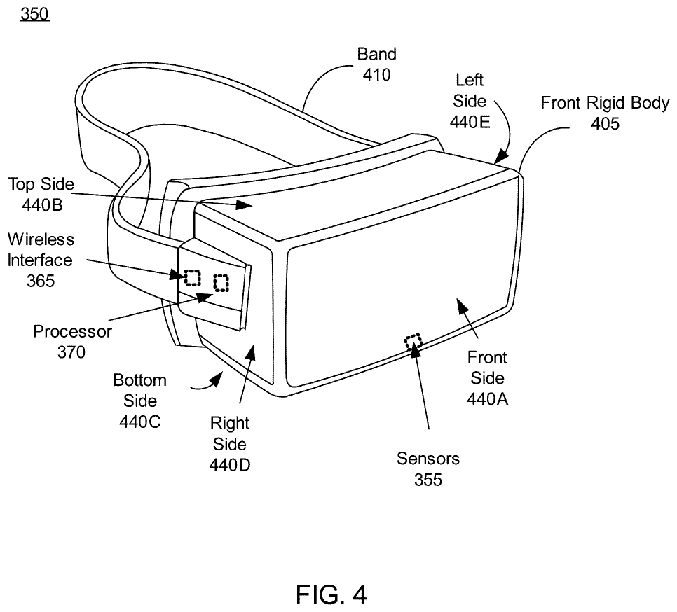

FIG. 4 is a diagram of a HWD 350, in accordance with an example embodiment. In some embodiments, the HWD 350 includes a front rigid body 405 and a band 410. The front rigid body 405 includes the electronic display 375 (not shown in FIG. 4), the lens 380 (not shown in FIG. 4), the sensors 355, the eye trackers 360A, 360B, the communication interface 365, and the image renderer 370. In the embodiment shown by FIG. 4, the sensors 355 are located within the front rigid body 405, and may not visible to the user. In other embodiments, the HWD 350 has a different configuration than shown in FIG. 4. For example, the image renderer 370, the eye trackers 360A, 360B, and/or the sensors 355 may be in different locations than shown in FIG. 4.

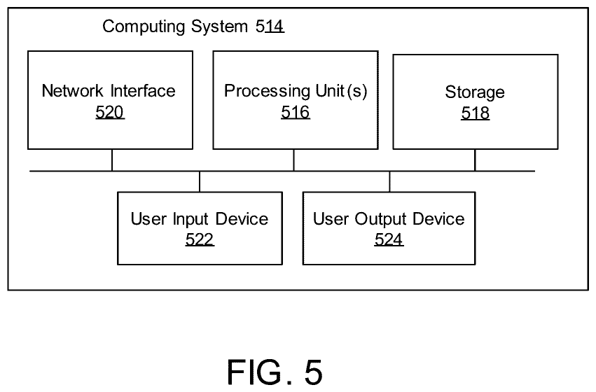

Various operations described herein can be implemented on computer systems. FIG. 5 shows a block diagram of a representative computing system 514 usable to implement the present disclosure. In some embodiments, the console 110, the HWD 150 or both of FIG. 1 are implemented by the computing system 514. Computing system 514 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 514 can be implemented to provide VR, AR, MR experience. In some embodiments, the computing system 514 can include conventional computer components such as processors 516, storage device 518, network interface 520, user input device 522, and user output device 524.

Network interface 520 can provide a connection to a wide area network (e.g., the Internet) to which WAN interface of a remote server system is also connected. Network interface 520 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 520 may include a transceiver to allow the computing system 514 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 516. Similarly, a receiver may be configured to receive frames, slots or symbols and the processor unit 516 may be configured to process the frames. For example, the processor unit 516 can be configured to determine a type of frame and to process the frame and/or fields of the frame accordingly.

User input device 522 can include any device (or devices) via which a user can provide signals to computing system 514; computing system 514 can interpret the signals as indicative of particular user requests or information. User input device 522 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 524 can include any device via which computing system 514 can provide information to a user. For example, user output device 524 can include a display to display images generated by or delivered to computing system 514. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 524 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 516 can provide various functionality for computing system 514, including any of the functionality described herein as being performed by a server or client, or other functionality associated with message management services.

It will be appreciated that computing system 514 is illustrative and that variations and modifications are possible. Computer systems used in connection with the present disclosure can have other capabilities not specifically described here. Further, while computing system 514 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

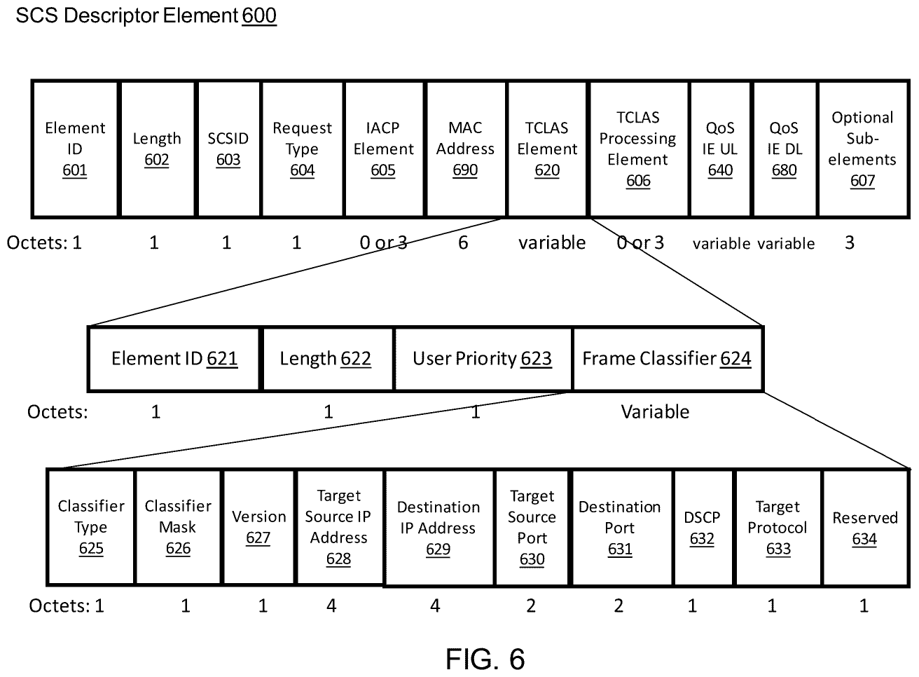

FIG. 6 illustrates an example format of an SCS descriptor element field (or SCS descriptor IE) 600, according to an example implementation of the present disclosure. The SCS descriptor IE 600 may include the fields of element ID 601, length 602, SCSID (or SCSID) 603, request type 604, intra-access category priority element 605, one or more TCLAS elements 620, TCLAS processing element 606, uplink QoS characteristic element (QoS IE UL) 640, downlink QoS characteristic element (QoS IE DL) 680, and/or one or more sub-elements 607 (optional). The TCLAS element fields 620 may include the fields of element ID 621, length 622, user priority 623, and/or frame classifier 624. The frame classifier field 624 may include the subfields of classifier type 625, classifier mask 626, version 627, target source IP address 628, destination IP address 629, target source port 630, destination port 631, DSCP 632, target protocol 633, and/or reserved 634.

In some embodiments, the SCS descriptor IE 600 may have a format similar to that of the SCS descriptor IE 200 (see FIG. 2A) except that (1) the SCS descriptor IE 600 can include the field of MAC address 690 and (2) the one or more TCLAS elements 620 can have a format different from the TCLAS elements 220 (see FIG. 2A).

In some embodiments, one or more traffic flows and/or one or more traffic profiles tied or pertaining to a target device (e.g., client A in FIG. 1A and FIG. 1B) may be carried/contained in an SCS descriptor element (e.g., SCS descriptor IE 600). In some embodiments, the SCS descriptor element 600 may include the MAC address field 690 that contains a MAC address of the target device, and the SCS descriptor element may be carried/transmitted by a proxy device (e.g., claim B in FIG. 1A and FIG. 1B). In some embodiments, an element/field/bits of the SCS descriptor element other than the MAC address field of the SCS descriptor element may include/contain a MAC address of the target device. In some embodiments, the SCS descriptor element may include/contain a MAC address that identifies the device for which the rest of the element is valid (e.g., MAC address of a target device). In some embodiments, the SCS descriptor element may include/contain one or more traffic profiles tied or pertaining to the target device in a TCLAS element (e.g., TCLAS element 620) that classifies and/or uniquely identifies a traffic flow between the target device and the AP. The one or more traffic profiles may include at least one of a source IP address, a source port, or a protocol, tied to or pertaining to the target device. In some embodiments, the TCLAS element 620 of the SCS descriptor element 600 may include the fields of target source IP address 628, target source port 630, and/or target protocol 633, which respectively can include/contain the source IP address, source port, and/or protocol, tied to or pertaining to the target device.

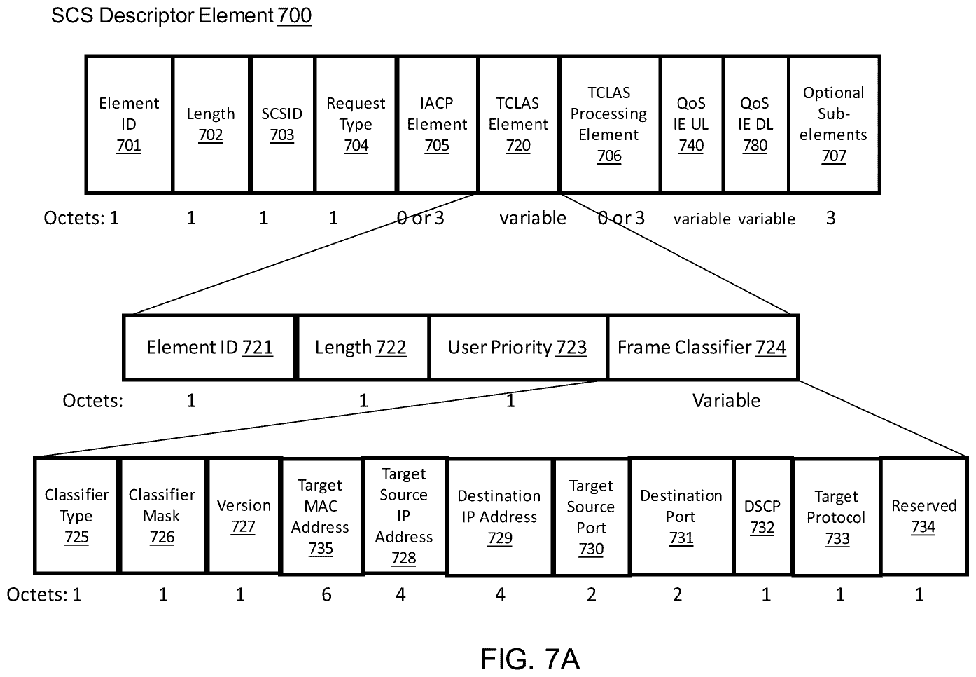

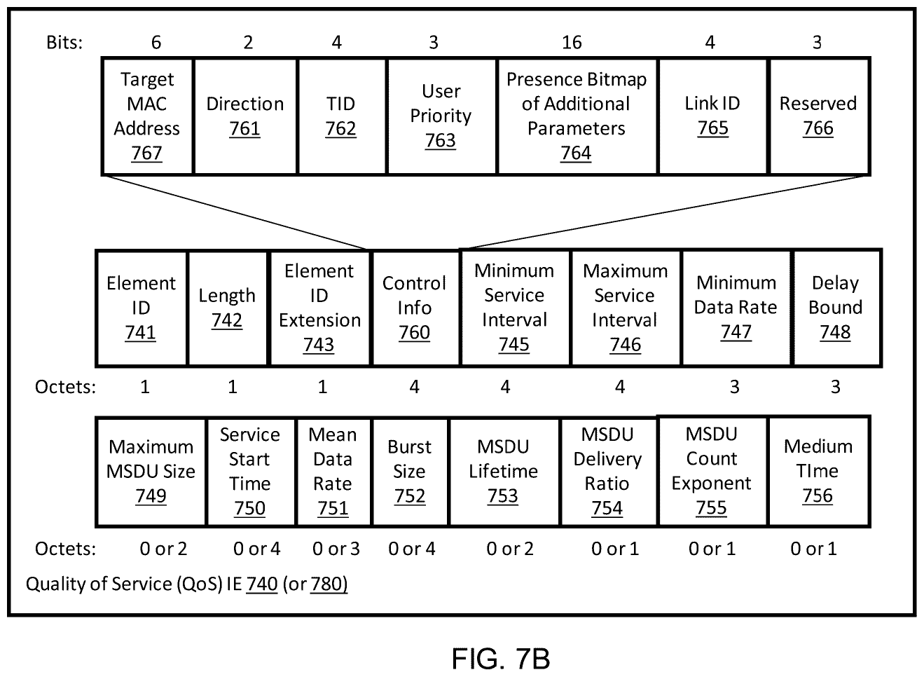

FIG. 7A and FIG. 7B illustrate an example format of an SCS descriptor element field 700, according to another example implementation of the present disclosure. The SCS descriptor IE 700 may include the fields of element ID 701, length 702, SCSID (or SCSID) 703, request type 704, intra-access category priority element 705, one or more TCLAS elements 720, TCLAS processing element 706, uplink QoS characteristic element (QoS IE UL) 740, downlink QoS characteristic element (QoS IE DL) 780, and/or one or more sub-elements 707 (optional). The TCLAS element fields 720 may include the fields of element ID 721, length 722, user priority 723, and/or frame classifier 724. The frame classifier field 724 may include the subfields of classifier type 725, classifier mask 726, version 727, target MAC address 735, target source IP address 728, destination IP address 729, target source port 730, destination port 731, DSCP 732, target protocol 733, and/or reserved 734. Referring to FIG. 7B, each of the QoS IE UL 740 and the QoS IE DL 780 may include the fields of element ID 741, length 742, element ID extension 743, control information 760, minimum service interval 745, maximum service interval 746, minimum data rate 747, delay bound 748, maximum MSDU size 749, service start time 750, mean data rate 751, burst size 752, MSDU lifetime 753, MSDU delivery ratio 754, MSDU count exponent 755, and/or medium time 756. In some embodiments, the field of control information 760 may include the subfields of target MAC address 767, direction 761, TID 762, user priority 763, presence bitmap or additional parameters 764, link ID 765, and/or reserved 766.

In some embodiments, the SCS descriptor IE 700 may have a format similar to that of the SCS descriptor IE 200 (see FIG. 2A and FIG. 2B) except that (1) the one or more TCLAS elements 720 can have a format different from that of the TCLAS elements 220 (see FIG. 2A) and (2) each of the QoS IE UL 740 and the QoS IE DL 780 can have a format different from that of each of the QoS IE UL 240 and the QoS IE DL 280 (see FIG. 2B).

In some embodiments, a MAC address of the target device may be added to one or more elements contained within the SCS descriptor element (e.g., SCS descriptor element 700) carried by the proxy device. In some embodiments, the MAC address of the target device may be added to the target MAC address subfield 735 of the TCLAS element 720 contained in the SCS descriptor element 700. In some embodiments, the frame classifier field 724 of the TCLAS element 720 that classifies and/or uniquely identifies a traffic flow (between the target device and the AP) may include the subfields of target MAC address 735, target source IP address 728, target source port 730, and/or target protocol 733, which respectively include/contain a MAC address, a source IP address, a source port and/or protocol of the target device (or tied to or pertaining to the target device).

In some embodiments, the MAC address of the target device may be added to the target MAC address subfield 767 of the control information field 760 of the QoS IE UL 740 or QoS IE DL 780 that characterizes a traffic flow between the target device and the AP in terms of required QoS parameters. In some embodiments, the MAC address of the target device (specified in the QoS IE UL 740 or QoS IE DL 780) may act as the key to map QoS characteristics (specified in the QoS IE UL 740 or QoS IE DL 780) to a traffic flow between the target device and the AP.

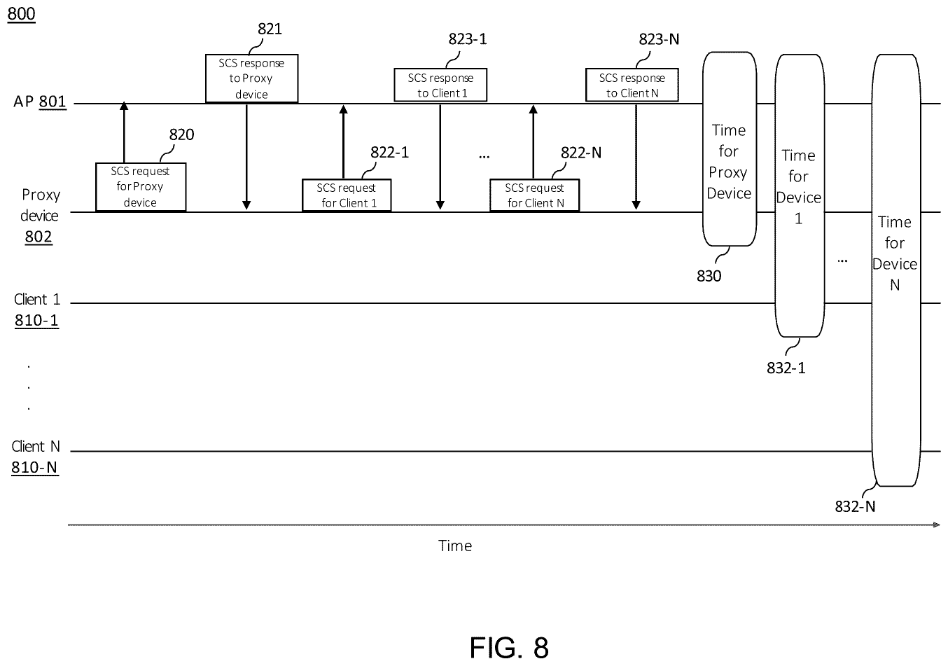

FIG. 8 is a block diagram of a system workflow 800 in which a proxy client device (or proxy device) 802 and an AP 801 communicate data relating to QoS information, according to an example implementation of the present disclosure. In some embodiments, a proxy QoS management protocol may define and/or describe various procedures relating to indication of traffic profile information between (1) a client device that does not support/implement the use of SCS descriptors (e.g., “client A” in FIG. 1A and FIG. 1B, or client 1 (810-1), . . . , client N (810-N)) and (2) an access point (e.g., AP, 110, 160, 801) through a client device (e.g., “client B” in FIG. 1A and FIG. 1B, or proxy device 802) that supports/implements the use of SCS descriptors. The proxy device 802 may carry traffic profile details of other client devices (or target devices) 810-1, . . . , 810-N in the network (e.g., WLAN).

In some embodiments, the proxy device 802 may specify traffic profile information or QoS information relating to one or more target devices using a modified version of SCS descriptor element (e.g., SCS descriptor element 600, 700). In some embodiments, an SCS descriptor element may be modified such that the field of MAC address (e.g., MAC address field 690) may be added to the SCS descriptor element that identifies a target device for which the traffic profile information is conveyed in the SCS descriptor element. The MAC address field may include/contain a MAC address of the target device. In some embodiments, the MAC address field may be added to the SCS descriptor element itself (e.g., the MAC address field 690 of the SCS descriptor element 600). In some embodiments, the MAC address field may be added to one of the elements contained within the SCS descriptor element (e.g., the target MAC address subfield 735 of the TCLAS element 720 contained within the SCS descriptor element 700). In some embodiments, the proxy device 802 may use an SCS element to identity of the target device (e.g., client devices 810-1, . . . , 810-N), and to specify a traffic profile and/or QoS requirements for a traffic flow between the identified target device and the AP 801.

In some embodiments, the one or more target devices (e.g., client devices 810-1, . . . , 810-N which may not support and/or implement the use of SCS descriptor) may communicate, to the proxy device 802 (which may support and/or implement the use of SCS descriptor), traffic profile information and QoS information relating to the target devices 810-1, . . . , 810-N. The traffic profile information may include one or more of MAC address, source IP address, source port, transport protocol of a traffic flow between the target devices 810-1, . . . , 810-N and the AP 801. The QoS information may include QoS requirements of the traffic flow between the target devices 810-1, . . . , 810-N and the AP 801. The QoS information may be specified in one or more fields in a QoS characteristics element (or QoS IE). In some embodiments, the traffic information and/or QoS information may be exchanged and/or communicated between the one or more target devices 810-1, . . . , 810-N and the proxy device 802 at the time of application setup (e.g., when the target devices 810-1, . . . , 810-N and/or the proxy device 802 set up an application that performs communication between the target devices 810-1, . . . , 810-N and the proxy device 802).

Referring to FIG. 8, in some embodiments, the proxy device 802 may send, to the AP 801, an SCS request 820 (e.g., SCS request frame) for specifying one or more streams relating to the proxy device 802. In response to the SCS request 820 for the proxy device, the AP 801 may send a corresponding SCS response 821 (e.g., SCS response frame). The proxy device 802 may send, to the AP 801, an SCS request 822-1, . . . , 822-N (e.g., SCS request frame) for specifying one or more streams relating to each of a plurality of client devices (as target devices), separately. In response to the respective SCS request for each client device, the AP may send a corresponding SCS response 823-1, . . . , 823-N (e.g., SCS response frame). In some embodiments, the SCS request frame for each client device may include a modified version of SCS descriptor element (e.g., SCS descriptor element 600 or 700) such that the modified SCS descriptor element contain traffic profile information and/or QoS information relating to traffic between each client device and the AP. In some embodiments, in response to receiving the SCS request frames for the plurality of client devices and sending the SCS response frames corresponding to the SCS request frames, the AP 801 may schedule/allocate respective times for the proxy device (e.g., time 830 allocated for proxy device) and each of the plurality of client devices (e.g., times 832-1, . . . , 832-N allocated for the plurality of client devices 810-1, . . . , 810-N). In some embodiments, the AP may schedule/allocate respective times for the proxy device and each of the plurality of client devices in the same order as that of receiving requests corresponding to the proxy device and each of the plurality of client devices (see FIG. 8). In some embodiments, the AP may schedule/allocate respective times for the proxy device and each of the plurality of client devices in an order different from that of receiving requests corresponding to the proxy device and each of the plurality of client devices (not shown).

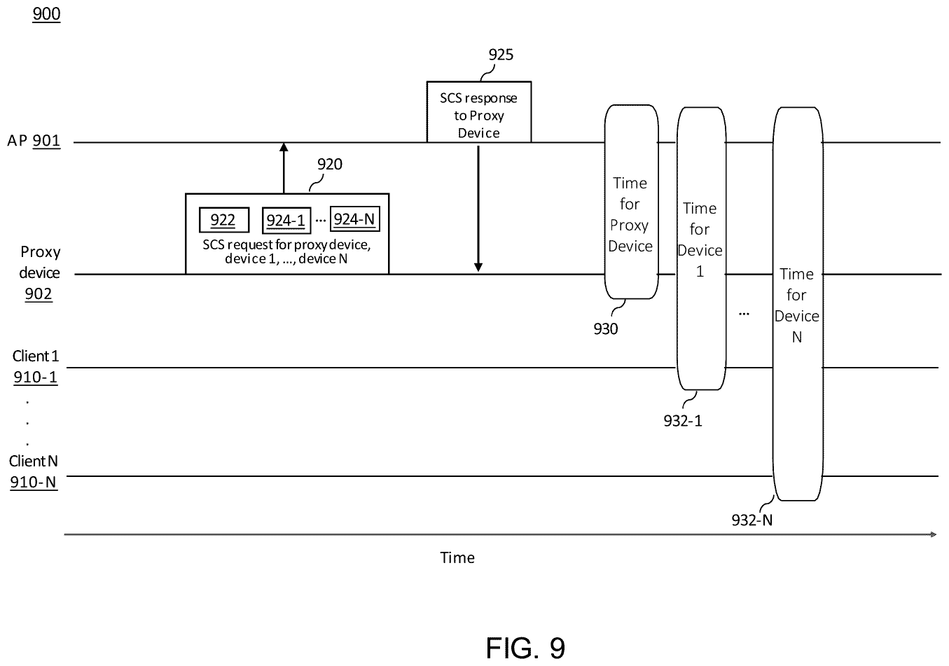

FIG. 9 is a block diagram of a system workflow 900 in which a proxy client device (or proxy device) 902 and an AP 901 communicate data relating to QoS information, according to another example implementation of the present disclosure. In some embodiments, the proxy device 902 may send, to the AP 901, a single SCS request 920 (e.g., a single SCS request frame) for specifying one or more streams relating to the proxy device 902 as well as a plurality of client devices (as target devices) 910-1, . . . , 910-N. In some embodiments, the single SCS request frame for the proxy device and the plurality of client devices may include (1) an SCS descriptor element 922 containing traffic profile information and/or QoS information relating to traffic between the proxy device 902 and the AP 901 and (2) a plurality of modified SCS descriptor elements 924-1, . . . , 924-N such that each of the plurality of modified SCS descriptor elements 924-1, . . . , 924-N includes/contains traffic profile information and/or QoS information relating to traffic between each client device (910-1, . . . , 910-N) and the AP, respectively. In response to receiving the single SCS request frame 920, the AP may send a corresponding SCS response 925 (e.g., SCS response frame). In some embodiments, in response to receiving the single SCS request frame and sending the corresponding SCS response frame, the AP may schedule/allocate respective times for the proxy device (e.g., time 930 allocated for the proxy device 902) and each of the plurality of client devices. In some embodiments, the AP may schedule/allocate respective times for the proxy device and each of the plurality of client devices in the same order as an order of the SCS descriptor elements specified in the single SCS request frame (see FIG. 9). In some embodiments, the AP may schedule/allocate respective times for the proxy device and each of the plurality of client devices in an order different from an order of the SCS descriptor elements specified in the single SCS request frame (not shown).

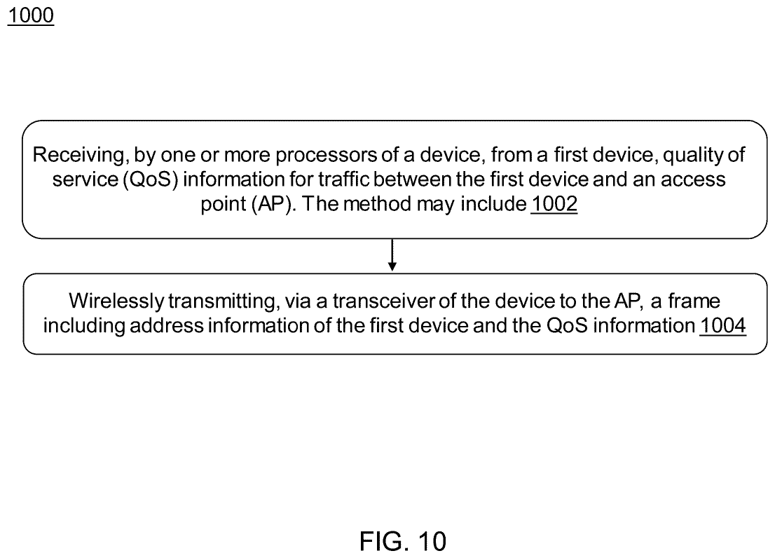

FIG. 10 is a flowchart showing a process of communicating data relating to QoS information between a client device (as a proxy device) and an AP, according to an example implementation of the present disclosure. In some embodiments, the process 1000 is performed by a device (e.g., client B in FIG. 1A and FIG. 1B, a proxy device 802, 902, a console 310, a HWD 350, or a non-AP STA). In some embodiments, the process 1000 is performed by other entities. In some embodiments, the process 1000 includes more, fewer, or different steps than shown in FIG. 10.

In one approach, the device may receive 1002, from at least a first device (e.g., client A in FIG. 1A and FIG. 1B, client devices 810-1, . . . , 810-N, client devices 910-1, . . . , 910-N, a console 310, a HWD 350, a non-AP STA) quality of service (QoS) information for traffic between the first device and an AP (e.g., AP 110, AP 160, AP 801, AP 901). In some embodiments, the QoS information may include at least one of one or more traffic profiles or one or more QoS requirements for one or more traffic flows between the first device and the AP.

In some embodiments, the frame may be a stream classification service (SCS) request frame (e.g., SCS request frames 820, 822-1, . . . , 822-N, SCS request frame 920). The device may receive from the AP, an SCS response frame (e.g., SCS response frames 821, 823-1, . . . , 823-N, SCS response frame 925) in response to the SCS request frame. In some embodiments, the frame may include one or more stream classification service (SCS) descriptor elements (e.g., SCS descriptor element 600, 700), which include/contain the address information of the first device (e.g., MAC address field 690, target source IP address 628, target source port 630, target MAC address subfield 735, target source IP address 728, target source port 730, target MAC address 767) and/or the QoS information (e.g., QoS IE UL 640, 740, QoS IE UL 680, 780).

In one approach, the device may wirelessly transmit 1004, via a transceiver of the device to the AP, a frame (e.g., SCS request frame 822-1, . . . , 822-N, SCS request frame 920) including address information of the first device and/or the QoS information. In some embodiments, the address information of the first device may include at least one of MAC address (e.g., MAC address field 690, target MAC address subfield 735, target MAC address 767), IP address (e.g., target source IP address 628, target source IP address 728), or port of the first device (e.g., target source port 630, target source port 730).

In some embodiments, the one or more SCS descriptor elements may include a subfield of traffic class (TCLAS) element (e.g., TCLAS element 620, 720). The subfield of TCLAS element may include the address information of the first device (e.g., target source IP address 628, target source port 630, target MAC address subfield 735, target source IP address 728, target source port 730). In some embodiments, the one or more SCS descriptor elements may include a subfield of medium access control (MAC) address which is set to a MAC address of the first device. In some embodiments, the one or more SCS descriptor elements may include a subfield of QoS characteristics element (e.g., target MAC address 767 of QoS IE 740) which is set to a MAC address of the first device.

In some embodiments, the one or more SCS descriptor elements may include a first SCS descriptor element (e.g., SCS descriptor element 922) and/or a second SCS descriptor element (e.g., SCS descriptor element 924-1). The first SCS descriptor element may include the address information of the first device and the QoS information. The second SCS descriptor element may include address information of a second device and QoS information for traffic between the second device and the AP.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

1. A device comprising:
one or more processors configured to:
receive, via a transceiver from a first device, quality of service (QoS) information for traffic between the first device and an access point (AP); and
wirelessly transmit, via the transceiver to the AP, a frame including address information of the first device and the QoS information.

2. The device according to claim 1, wherein the QoS information includes at least one of one or more traffic profiles or one or more QoS requirements for one or more traffic flows between the first device and the AP.

3. The device according to claim 1, wherein the address information of the first device includes at least one of medium access control (MAC) address, internet protocol (IP) address, or port of the first device.

4. The device according to claim 1, wherein the frame is a stream classification service (SCS) request frame.

5. The device according to claim 4, wherein the one or more processors are configured to receive, via the transceiver from the AP, an SCS response frame in response to the SCS request frame.

6. The device according to claim 4, wherein:
the frame includes one or more stream classification service (SCS) descriptor elements, which contain the address information of the first device and the QoS information.

7. The device according to claim 6, wherein:
the one or more SCS descriptor elements include a subfield of traffic class (TCLAS) element, and
the subfield of TCLAS element includes the address information of the first device.

8. The device according to claim 6, wherein the one or more SCS descriptor elements include a subfield of medium access control (MAC) address which is set to a MAC address of the first device.

9. The device according to claim 6, wherein the one or more SCS descriptor elements include a subfield of QoS characteristics element which is set to a MAC address of the first device.

10. The device according to claim 6, wherein
the one or more SCS descriptor elements include a first SCS descriptor element and a second SCS descriptor element,
the first SCS descriptor element includes the address information of the first device and the QoS information, and
the second SCS descriptor element includes address information of a second device and QoS information for traffic between the second device and the AP.

11. A method comprising:
receiving, by a device from a first device, quality of service (QoS) information for traffic between the first device and an access point (AP); and
wirelessly transmitting, by the device to the AP, a frame including address information of the first device and the QoS information.

12. The method according to claim 11, wherein the QoS information includes at least one of one or more traffic profiles or one or more QoS requirements for one or more traffic flows between the first device and the AP.

13. The method according to claim 11, wherein the address information of the first device includes at least one of medium access control (MAC) address, internet protocol (IP) address, or port of the first device.

14. The method according to claim 11, wherein the frame is a stream classification service (SCS) request frame.

15. The method according to claim 14, further comprising:
receiving, by the device from the AP, an SCS response frame in response to the SCS request frame.

16. The method according to claim 14, wherein:
the frame includes one or more stream classification service (SCS) descriptor elements, which contain the address information of the first device and the QoS information.

17. The method according to claim 16, wherein:
the one or more SCS descriptor elements include a subfield of traffic class (TCLAS) element, and
the subfield of TCLAS element includes the address information of the first device.

18. The method according to claim 16, wherein the one or more SCS descriptor elements include a subfield of medium access control (MAC) address which is set to a MAC address of the first device.

19. The method according to claim 16, wherein the one or more SCS descriptor elements include a subfield of QoS characteristics element which is set to a MAC address of the first device.

20. The method according to claim 16, wherein
the one or more SCS descriptor elements include a first SCS descriptor element and a second SCS descriptor element,
the first SCS descriptor element includes the address information of the first device and the QoS information, and
the second SCS descriptor element includes address information of a second device and QoS information for traffic between the second device and the AP.
